(19) United States
(12) Patent Application Publication
(10) Pub. No.: US 2008/0217293 A1
(43) Pub. Date: Sep. 11, 2008

(54) PROCESSING SYSTEM AND METHOD FOR PERFORMING HIGH THROUGHPUT NON-PLASMA PROCESSING

(75) Inventor: Shunichi Iimuro, Burlington, MA (US)

Correspondence Address: WOOD, HERRON & EVANS, LLP (TOKYO ELECTRON), 2700 CAREW TOWER, 441 VINE STREET, CINCINNATI, OH, 45202, US

(73) Assignee: TOKYO ELECTRON LIMITED, Tokyo (JP)

(21) Appl. No.: 11/682,625

(22) Filed: Mar. 6, 2007

(51) Int. Cl. B44C 1/22; C23F 1/00

(52) U.S. Cl. 216/57; 156/345.29

(57) ABSTRACT

Embodiments of apparatus and methods for performing high throughput non-plasma processing are generally described herein. Other embodiments may be described and claimed.

### FIELD OF THE INVENTION

The field of invention relates generally to the field of semiconductor integrated circuit manufacturing and, more specifically, to a system and method for performing high throughput non-plasma processing.

### BACKGROUND OF THE INVENTION

During semiconductor processing, a plasma etch process is typically utilized to remove or etch material along fine lines or within vias or contacts patterned on a semiconductor substrate. The plasma etch process generally involves positioning the semiconductor substrate with an overlying patterned, protective layer, for example a photoresist layer, in a processing chamber. Once the substrate is positioned within the chamber, a dissociative, ionizable gas mixture is introduced within the chamber at a pre-specified flow rate, while a vacuum pump is throttled to achieve an ambient process pressure. Thereafter, a plasma is formed when a fraction of the gas species present in the gas mixture is ionized by electrons heated via the transfer of radio frequency (RF) power either inductively or capacitively, or microwave power using, for example, electron cyclotron resonance (ECR). Moreover, collisions between the heated electrons and the gas molecules serve to dissociate some of the ambient gas species and create reactant one or more species suitable for the exposed surface etch chemistry. Once the plasma is formed, the plasma etches one or more selected surfaces of the substrate.

The plasma etch process is adjusted to achieve appropriate conditions, including an appropriate concentration of desirable reactant and ion populations to etch various features (e.g. trenches, vias, contacts, gates, etc.) in the selected regions of the substrate. Initiating and sustaining a consistent and repeatable plasma process requires a significant application of power, specialized equipment, and regular maintenance.

Etch processing is normally performed using a single wafer configuration cluster tool, comprising a loadlock chamber, a wafer transfer station, and one or more common process chambers that share a single wafer handler in the wafer transfer station to load and unload all process chambers. The single wafer configuration allows one wafer to be processed per chamber in a manner that provides consistent and repeatable etch characteristics both within wafer and from wafer to wafer.

While the etch cluster tool provides the characteristics necessary for etching various features on a semiconductor substrate, it would be an advance in the art of semiconductor processing to increase the throughput of a process tool while providing necessary process characteristics.

### BRIEF DESCRIPTION OF THE DRAWINGS

The accompanying drawings, which are incorporated in and constitute a part of this specification, illustrate embodiments of the invention and, together with the detailed description of the embodiments given below, serve to explain the principles of the invention.

FIG. 1 is a schematic side view of an embodiment of a processing system including a first treatment system, a second treatment system, and a transfer system for the first and second treatment systems;

FIG. 2 is a schematic top view of the transfer system of FIG. 1;

FIG. 3 is a schematic side view similar to FIG. 1 of an alternative embodiment of a processing system;

FIG. 4 is a schematic side view in partial cross section of an embodiment of a processing system that includes a chemical treatment system with a temperature controlled substrate platform and a gas distribution system, a thermal treatment system with a substrate lifter assembly, and a thermal insulation assembly thermally insulating the chemical treatment chamber from the thermal treatment chamber;

FIG. 5 is a schematic side view in partial cross section of the chemical treatment system of FIG. 4;

FIG. 6 is a schematic side view in partial cross-section of the thermal treatment system according of FIG. 4;

FIG. 7 is a schematic cross-sectional view of the temperature controlled substrate platform of the chemical treatment system of FIG. 4;

FIG. 8 is a schematic cross-sectional view of the gas distribution system of FIG. 4;

FIG. 9 is a schematic cross-sectional view of another embodiment of a gas distribution system similar to FIG. 8;

FIG. 10 is an expanded view of a portion of the gas distribution system shown in FIG. 8;

FIG. 11 is a perspective view of the gas distribution system of FIG. 8;

FIG. 12 is a view of the substrate lifter assembly of FIGS. 4 and 6;

FIG. 13 is a sideview of the thermal insulation assembly of FIG. 4;

FIG. 14 is a disassembled cross-sectional side view of the thermal insulation assembly of FIG. 13; and

FIG. 15 is a flow diagram for processing a plurality of substrates.

### DETAILED DESCRIPTION

An apparatus and method for performing high throughput non-plasma processing is disclosed in various embodiments. However, one skilled in the relevant art will recognize that the various embodiments may be practiced without one or more of the specific details, or with other replacement and/or additional methods, materials, or components. In other instances, well-known structures, materials, or operations are not shown or described in detail to avoid obscuring aspects of various embodiments of the invention. Similarly, for purposes of explanation, specific numbers, materials, and configurations are set forth in order to provide a thorough understanding of the invention. Nevertheless, the invention may be practiced without specific details. Furthermore, it is understood that the various embodiments shown in the figures are illustrative representations and are not necessarily drawn to scale.

Reference throughout this specification to “one embodiment” or “an embodiment” or variation thereof means that a particular feature, structure, material, or characteristic described in connection with the embodiment is included in at least one embodiment of the invention, but do not denote that they are present in every embodiment. Thus, the appearances of the phrases such as “in one embodiment” or “in an embodiment” in various places throughout this specification are not necessarily referring to the same embodiment of the invention. Furthermore, the particular features, structures, materials, or characteristics may be combined in any suitable manner in one or more embodiments. Various additional layers and/or structures may be included and/or described features may be omitted in other embodiments.

Various operations will be described as multiple discrete operations in turn, in a manner that is most helpful in understanding the invention. However, the order of description should not be construed as to imply that these operations are necessarily order dependent. In particular, these operations need not be performed in the order of presentation. Operations described may be performed in a different order than the described embodiment. Various additional operations may be performed and/or described operations may be omitted in additional embodiments.

There is a general need for a system and method for high-throughput treatment of a plurality of substrates, and to a system and method for high-throughput chemical and thermal treatment of a plurality of substrates. By using a plurality of substrate holders and a dedicated handler per station, the chemical and thermal treatment throughput of a plurality of substrates may be improved.

One embodiment of a processing system for treating a plurality of substrates may comprise a chemical treatment chamber, a thermal treatment chamber, and an isolation assembly. The chemical treatment chamber may comprise a plurality of temperature controlled substrate platforms, a first vacuum pumping system coupled to the chemical treatment chamber, a first heat exchange element, and a gas distribution system to deliver a plurality of process gases into a process space in the chemical treatment chamber to chemically alter a substrate surface layer. The thermal treatment chamber may comprise a plurality of temperature controlled substrate holders, a second heat exchange element, and a second vacuum pumping system coupled to the thermal treatment chamber. Finally, the isolation assembly may comprise a dedicated handler to transfer a plurality of substrates between the chemical treatment chamber and the thermal treatment chamber, disposed between the chemical treatment chamber and the thermal treatment chamber.

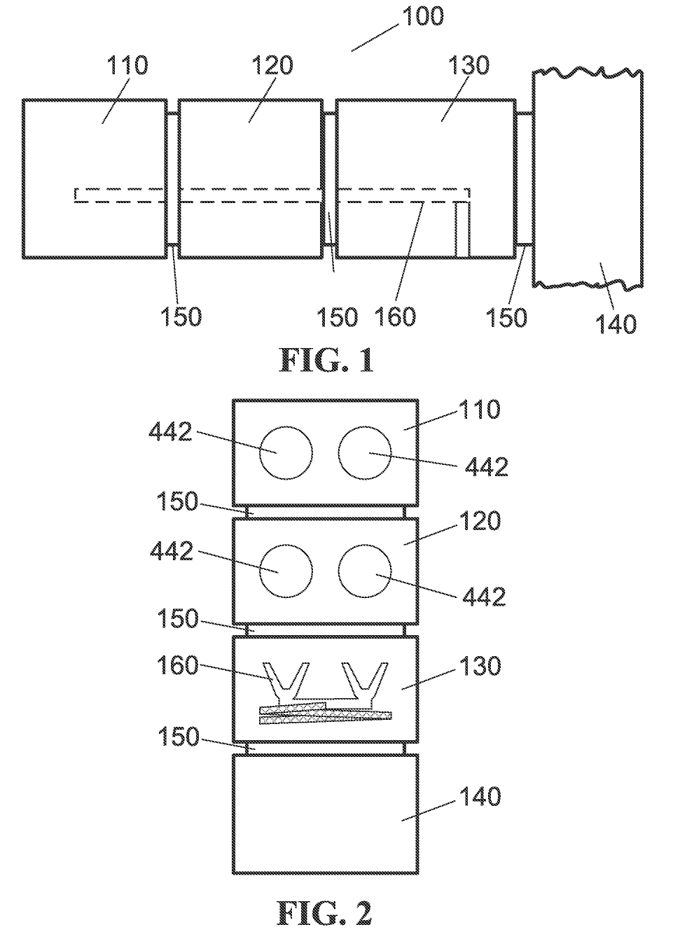

With reference to FIGS. 1 and 2, a processing system 100 is shown that is used for processing a plurality of substrates where, for example, the process is used to trim a mask layer. The processing system 100 comprises a first treatment system 110 and a second treatment system 120 coupled to the first treatment system 110. In one embodiment, the first treatment system 110 is a chemical treatment system, and the second treatment system 120 is a thermal treatment system. In another embodiment, the second treatment system 120 is a substrate rinsing system, such as a water rinsing system. The processing system 100 further includes a transfer system 130 coupled to the first treatment system 110 to transfer substrates in and out of the first treatment system 110 and the second treatment system 120. The transfer system 130 is also used to exchange substrates with a multi-element manufacturing system 140. The multi-element manufacturing system 140 may comprise a loadlock element to allow cassettes of substrates to cycle between ambient conditions and low pressure conditions.

The first and second treatment systems 110, 120, and the transfer system 130 can, for example, comprise a processing element within the multi-element manufacturing system 140. The transfer system 130 may comprise a dedicated handler 160 for moving a plurality of substrates between the first treatment system 110, the second treatment system 120 and the multi-element manufacturing system 140. For example, the dedicated handler 160 may be dedicated to transferring the plurality of substrates between the treatment systems (first treatment system 110 and second treatment system 120) and the multi-element manufacturing system 140, however the embodiment is not so limited. Additionally, transfer system 130 may exchange substrates 442 with one or more substrate cassettes (not shown).

In one embodiment, and although only two treatment systems are shown in FIGS. 1 and 2, the multi-element manufacturing system 140 may permit the transfer of substrates to and from processing elements including such devices as etch systems, deposition systems, coating systems, patterning systems, metrology systems, etc. In order to isolate the processes occurring in the first and second systems, an isolation assembly 150 is utilized to couple each system. For instance, the isolation assembly 150 may comprise at least one of a thermal insulation assembly to provide thermal isolation or a gate valve assembly to provide vacuum isolation. Of course, treatment systems 110 and 120, and transfer system 130, may be placed in any sequence. Additionally, for example, the transfer system 130 can serve as part of the isolation assembly 150.

In the processing system 100, a substrate 442 is processed side-by-side with another substrate 442 in the same treatment system. In an alternative embodiment, the substrates 442 may be processed front-to-back. Although only two substrates are shown in each treatment system in FIG. 2, two or more substrates may be processed in parallel in each treatment system.

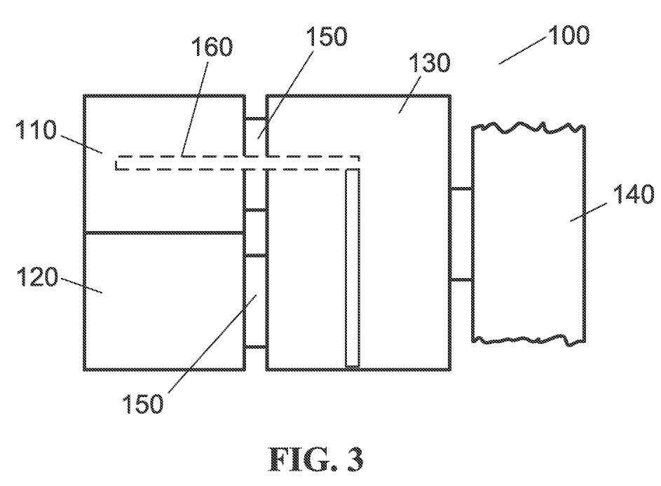

With reference to FIG. 3 in which like reference numerals refer to like features in FIG. 1 and in an alternative embodiment, a processing system 100a for processing a plurality of substrates places the first treatment system 110 in a vertically stacked arrangement atop the second treatment system 120. Processing system 100a is otherwise substantially identical to processing system 100 (FIGS. 1 and 2).

In general, at least one of the first treatment system 110 and the second treatment system 120 of the processing system 100 depicted in FIG. 1 comprises at least two transfer openings to permit passage of the plurality of substrates. For example, as depicted in FIG. 1, the second treatment system 120 comprises two transfer openings, the first transfer opening permits the passage of the substrates between the first treatment system 110 and the second treatment system 120 and the second transfer opening permits the passage of the substrates between the transfer system 130 and the second treatment system 120. However, regarding the processing system 100 depicted in FIGS. 1 and 2 and the processing system 100a depicted in FIG. 3, each treatment system, respectively, comprises at least one transfer opening to permit passage of the plurality of substrates.

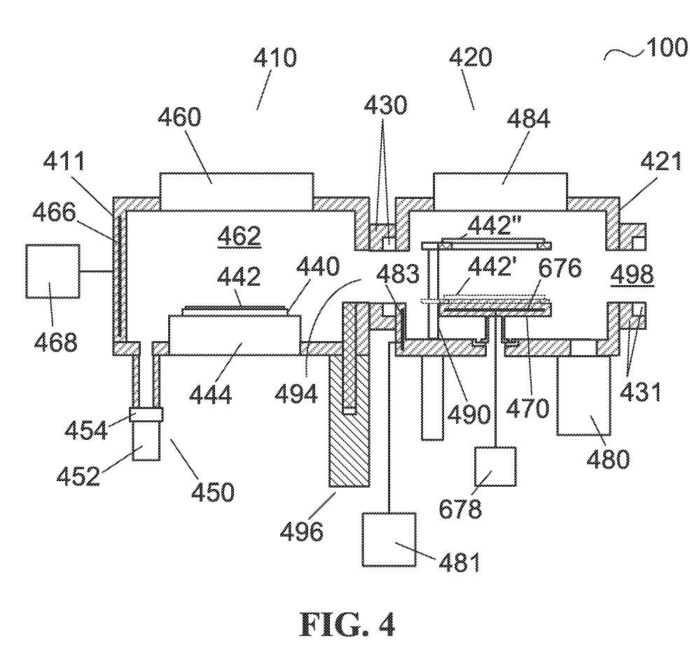

With reference to FIG. 4, an embodiment of processing system 100 for performing chemical treatment and thermal treatment of a plurality of substrates is presented. Processing system 100 comprises a chemical treatment system 410 and a thermal treatment system 420 coupled to the chemical treatment system 410. The chemical treatment system 410 comprises a chemical treatment chamber 411, which can be temperature-controlled. The thermal treatment system 420 comprises a thermal treatment chamber 421, which can also be temperature-controlled. The chemical treatment chamber 411 and the thermal treatment chamber 421 may be thermally insulated from one another using a thermal insulation assembly 430, and vacuum isolated from one another using a gate valve assembly 496, to be described in greater detail below.

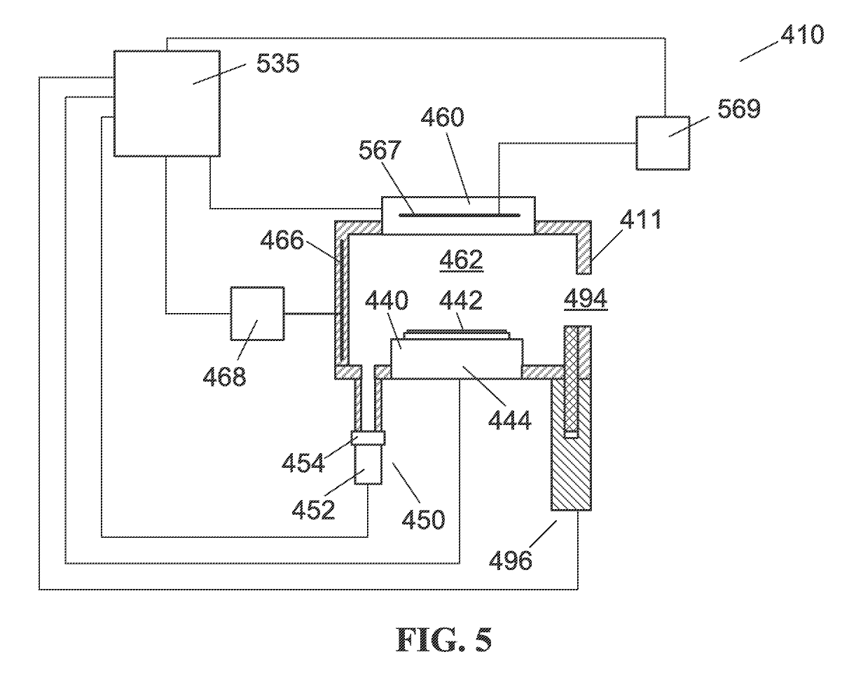

With reference to FIGS. 4, 5, and 7, the chemical treatment system 410 comprises a plurality of temperature controlled substrate platforms 440, a first vacuum pumping system 450 coupled in fluid communication with the chemical treatment chamber 411, and a gas distribution system 460 for introducing one or more process gases into a process space 462 within the chemical treatment chamber 411. The temperature controlled substrate platforms 440 are configured to be substantially thermally isolated from the chemical treatment chamber 411 and is further configured to support a plurality of substrates 442. The first vacuum pumping system 450 is configured to evacuate the chemical treatment chamber 411. The embodiment of the chemical treatment chamber 411 shown in FIGS. 4 and 5 illustrates the use of two temperature controlled substrate platforms 440, although the embodiment is not so limited. Additional temperature controlled substrate platforms (not shown) similar to platforms 440 may be included in each chemical treatment chamber 411 to allow a plurality of substrates to be processed in parallel.

The chemical treatment chamber 411, thermal treatment chamber 421, and thermal insulation assembly 430 define a common opening 494 through which the substrate 442 can be transferred. During processing, the common opening 494 can be sealed closed using a gate valve assembly 496 to permit independent processing in the two chambers 411 and 421. A transfer opening 498 is formed in the thermal treatment chamber 421 to permit substrate exchanges with a transfer system 130, as best shown in FIG. 1. For example, a second thermal insulation assembly 431 can be implemented to thermally insulate the thermal treatment chamber 421 from a transfer system 130 (FIG. 1). Although the opening 498 is illustrated as part of the thermal treatment chamber 421 (consistent with FIG. 1), the transfer opening 498 can be formed in the chemical treatment chamber 411 and not the thermal treatment chamber 421 (with reversed chamber positions from those shown in FIG. 1), or the transfer opening 498 can be formed in both the chemical treatment chamber 411 and the thermal treatment chamber 421 (as shown in FIG. 3).

The chemical treatment system 410 comprises a plurality of substrate platforms 440 and substrate platform assemblies 444 to provide several operational functions for thermally controlling and processing a plurality of substrates 442. The substrate platforms 440 and substrate platform assemblies 444 may comprise an electrostatic clamping system to electrostatically clamp the substrates 442 to the substrate platforms 440. To that end, each substrate platform 440 further comprises an electrostatic clamp (ESC) 728 comprising a ceramic layer 730, a clamping electrode 732 embedded in the ceramic layer 730, and a high-voltage (HV) DC voltage supply 734 coupled to the clamping electrode 732 using an electrical connection 736. The ESC 728 can, for example, be mono-polar or bi-polar. The design and implementation of such electrostatic chucks is well known to those skilled in the art of electrostatic clamping systems. Alternatively, each substrate platform 440 may include a mechanical clamping system for mechanically clamping one or more of the substrates 442.

Each of the substrate platforms 440 may, for example, further include a cooling system having a re-circulating coolant flow that receives heat from the substrate platforms 440 and transfers heat to a heat exchanger system (not shown), or when heating, transfers heat from the heat exchanger system (not shown) to the substrate platforms 440. In other embodiments, heating/cooling elements, such as resistive heating elements, or thermo-electric heaters/coolers can be included in the substrate platforms 440, as well as a chamber wall of the chemical treatment chamber 411.

With renewed reference to FIGS. 4 and 5, chemical treatment system 410 further comprises a temperature controlled chemical treatment chamber 411 that is maintained at an elevated temperature. For example, a heating element 466 may be electrically coupled to a temperature control unit 468, and the heating element 466 can be configured to transfer heat to the wall of the chemical treatment chamber 411. The temperature control unit 468 can, for example, comprise a controllable DC power supply electrically coupled with the heating element 466. A cooling element can also be employed in chemical treatment chamber 411. The temperature of the chemical treatment chamber 411 can be monitored using a temperature-sensing device such as a thermocouple (e.g. a K-type thermocouple, Pt sensor, etc.). Furthermore, a controller can utilize the temperature measurement as feedback to the wall temperature control unit 468 in order to control the temperature of the chemical treatment chamber 411.

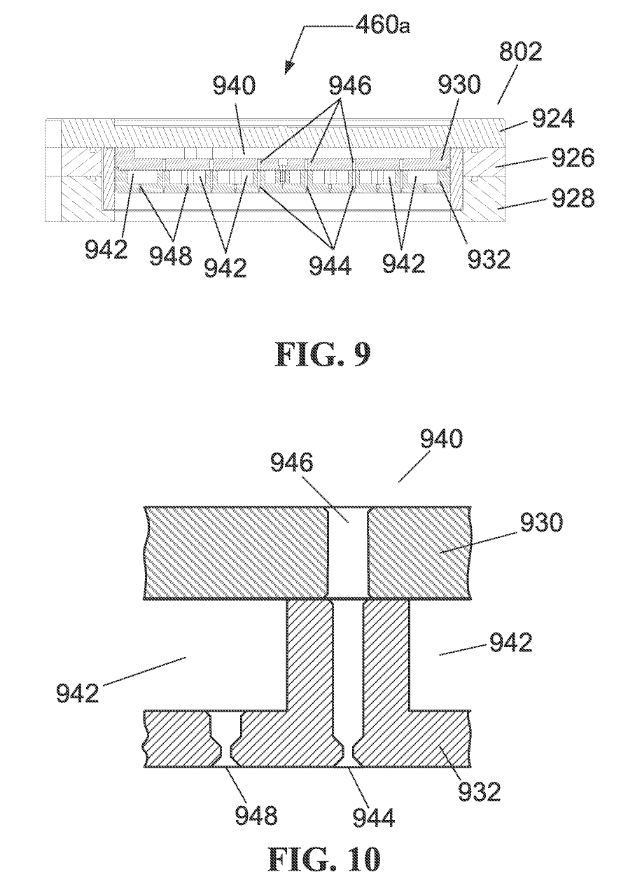

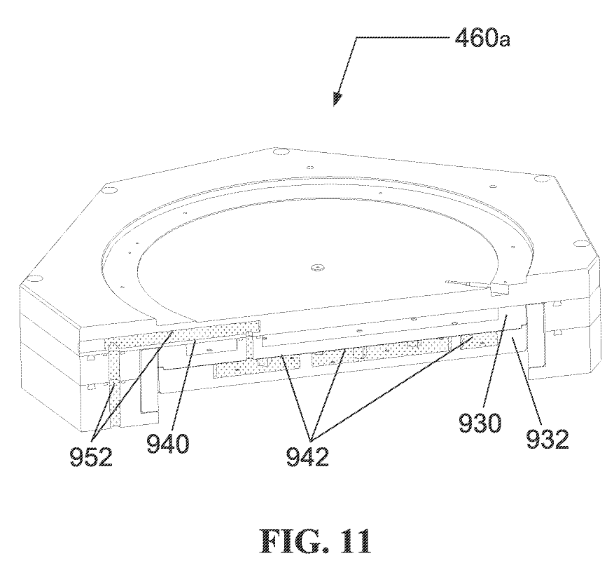

The temperature controlled gas distribution system 460 of the chemical treatment system 410 may be maintained at any selected temperature. For example, a heating element 567 can be electrically coupled to a temperature control unit 569, and the heating element 567 can be configured to transfer heat to the gas distribution system 460. The gas distribution system temperature control unit 569 can, for example, comprise a controllable DC power supply electrically coupled with the heating element 567. The temperature of the gas distribution system 460 can be monitored using a temperature-sensing device such as a thermocouple (e.g. a K-type thermocouple, Pt sensor, etc.). Furthermore, a controller can utilize the temperature measurement as feedback to the gas distribution system temperature control unit 569 in order to control the temperature of the gas distribution system 460. The gas distribution systems of FIGS. 9-11 can also incorporate a temperature control system. Alternatively, or in addition, cooling elements can be employed in any of the embodiments.

The first vacuum pumping system 450 can comprise a vacuum pump 452 and a gate valve 454 for throttling the chamber pressure. Vacuum pump 452 can, for example, include a turbo-molecular vacuum pump (TMP) capable of a pumping speed up to about 5000 liters per second or greater. For example, the TMP can be a Seiko STP-A803 vacuum pump, or an Ebara ET1301 W vacuum pump. TMPs are useful for low pressure processing, typically less than about 50 mTorr. For high pressure (i.e., greater than about 100 mTorr) or low throughput processing (i.e., no gas flow), a mechanical booster pump and dry roughing pump can be used.

Chemical treatment system 410 can further comprise a first controller 535 having a microprocessor, memory, and a digital I/O port capable of generating control voltages sufficient to communicate and activate inputs to chemical treatment system 410 as well as monitor outputs from chemical treatment system 410 such as temperature and pressure sensing devices. Moreover, the first controller 535 can be coupled to and can exchange information with substrate platform assembly 444, gas distribution system 460, first vacuum pumping system 450, gate valve assembly 496, wall temperature control unit 468, and gas distribution system temperature control unit 569. For example, a program stored in the memory can be utilized to activate the inputs to the aforementioned components of chemical treatment system 410 according to a process recipe. One example of the first controller 535 is a DELL PRECISION WORKSTATION 610™ commercially available from Dell Corporation (Austin, Tex.).

Each temperature controlled substrate platform 440 may comprise a chamber mating component 710 coupled to a lower wall of the chemical treatment chamber 411, an insulating component 712 coupled to the chamber mating component 710, and a temperature control component 714 coupled to the insulating component 712. The chamber mating and temperature control components 710, 714 can, for example, be fabricated from an electrically and thermally conducting material, such as aluminum, stainless steel, nickel, etc. The insulating component 712 can, for example, be fabricated from a thermally-resistant material, such as quartz, alumina, Teflon, etc., having an electrical conductivity and a thermal conductivity lower than that of the materials constituting the chamber mating and temperature control components 710, 714.

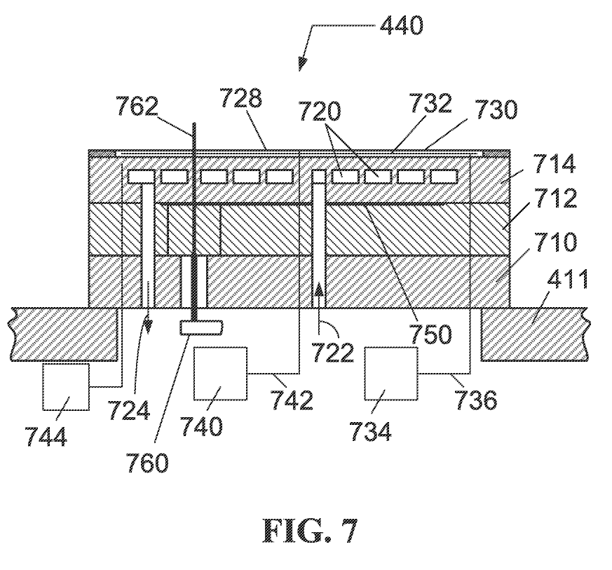

The temperature control component 714 can comprise heat exchange or temperature control elements such as cooling channels, heating channels, resistive heating elements, or thermoelectric elements. In the exemplary embodiment and as best illustrated in FIG. 7, the temperature control component 714 comprises a coolant channel 720 having a coolant inlet 722 and a coolant outlet 724. The coolant channel 720 can, for example, be a spiral passage within the temperature control component 714 that permits a flow rate of coolant, such as water, Fluorinert, Galden HT-135, etc., in order to provide conductive-convective cooling of the temperature control component 714. Alternatively, the temperature control component 714 can comprise an array of thermo-electric elements capable of heating or cooling a substrate depending upon the direction of electrical current flow through the respective elements. An exemplary thermo-electric element is one commercially available from Advanced Thermoelectric, Model ST-127-1.4-8.5M (a 40 mm by 40 mm by 3.4 mm thermo-electric device capable of a maximum heat transfer power of 72 W).

Each of the temperature controlled substrate platform 440 further comprises a back-side gas supply system 740 for supplying a heat transfer gas, such as an inert gas including helium (He), argon (Ar), xenon (Xe), krypton (Kr), a process gas, or other gas including oxygen (O₂), nitrogen (N₂), or hydrogen (H₂), to the backside of substrate 442 through at least one platform gas supply line 742, and at least one of a plurality of orifices and channels. The backside gas supply system 740 can, for example, be a multi-zone supply system such as a two-zone (center-edge) system, wherein the backside pressure can be varied radially from the center to edge and may be independently varied between the center and the edge of substrates 442. The presence of the heat transfer gas operates to improve the gas-gap thermal conductance between the substrate 442 and the substrate platform 440. Such a system may be omitted if temperature control of the substrates 442 is not required at elevated or reduced temperatures.

The insulating component 712 further comprises a thermal insulation gap 750 in order to provide additional thermal insulation between the temperature control component 714 and the underlying mating component 710. The thermal insulation gap 750 can be evacuated using a pumping system (not shown) or a vacuum line as part of first vacuum pumping system 450 and/or a second vacuum pumping system 480 and/or coupled to a gas supply (not shown) in order to vary its thermal conductivity. The gas supply can, for example, be the backside gas supply 740 used to couple heat transfer gas to the backside of the substrate 442.

The mating component 710 further comprises a lift pin assembly 760 capable of raising and lowering three or more lift pins 762 in order to vertically translate substrate 442 to and from an upper surface of the temperature controlled substrate platform 440 and one or more transfer planes in the processing system.

Each component 710, 712, and 714 further comprises fastening devices (such as bolts and tapped holes) in order to affix one component to another, and to affix the temperature controlled substrate platform 440 to the chemical treatment chamber 411. Furthermore, each component 710, 712, and 714 facilitates the passage of the above-described utilities to the respective component, and vacuum seals, such as elastomer o-rings, are utilized where necessary to preserve the vacuum integrity of the processing system.

The temperature of the substrate platform 440 can be monitored using a temperature sensing device 744 such as a thermocouple (e.g. a K-type thermocouple, Pt sensor, etc.). Furthermore, a controller can utilize the temperature measurement as feedback to the substrate platform assembly 444 in order to control the temperature of substrate platform 440. For example, at least one of a fluid flow rate, fluid temperature, heat transfer gas type, heat transfer gas pressure, clamping force, resistive heater element current or voltage, thermoelectric device current or polarity, etc. can be adjusted in order to affect a change in the temperature of substrate platform 440 and/or the temperature of the substrate 442.

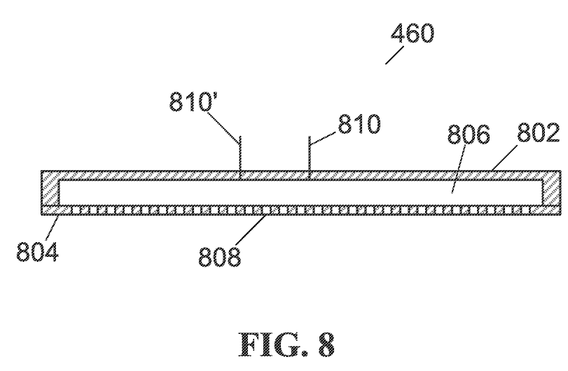

With reference to FIG. 8, the gas distribution system 460 of the chemical treatment system 410 further comprises a showerhead gas injection system having a gas distribution assembly 802, and a gas distribution plate 804 coupled to the gas distribution assembly 802 and configured to form a gas distribution plenum 806. Although not shown, gas distribution plenum 806 can comprise one or more gas distribution baffle plates. The gas distribution plate 804 further comprises one or more gas distribution orifices 808 to distribute a process gas from the gas distribution plenum 806 to the process space 462 within chemical treatment chamber 411. Additionally, one or more gas supply lines 810, 810′, etc. can be coupled to the gas distribution plenum 806 through, for example, the gas distribution assembly in order to supply a process gas comprising one or more gases. The process gas can, for example, comprise one or more of ammonia (NH₃), hydrogen fluoride (HF), H₂, O₂, carbon monoxide (CO), carbon dioxide (CO₂), Ar, and He, though the embodiment is not so limited.

With reference to FIGS. 9-11 in which like reference numerals refer to like features in FIGS. 4-8 and in accordance with an alternative embodiment, a gas distribution system 460a for distributing a process gas comprising at least two gases comprises a gas distribution assembly 802 having one or more components 924, 926, and 928, a first gas distribution plate 930 coupled to the gas distribution assembly 802, and a second gas distribution plate 932 coupled to the first gas distribution plate 930. The first gas distribution plate 930 is configured to couple a first gas to the process space 462 of chemical treatment chamber 411 (FIGS. 4 and 5). The second gas distribution plate 932 is configured to couple a second gas to the process space 462 of chemical treatment chamber 411.

The first gas distribution plate 930, when coupled to the gas distribution assembly 802, forms a first gas distribution plenum 940. Additionally, the second gas distribution plate 932, when coupled to the first gas distribution plate 930 forms a second gas distribution plenum 942. Gas distribution plenums 940 and 942 may comprise one or more gas distribution baffle plates (not shown). The second gas distribution plate 932 further comprises a first array of one or more orifices 944 coupled to and coincident with an array of one or more passages 946 formed within the first gas distribution plate 930, and a second array of one or more orifices 948. The first array of one or more orifices 944, in conjunction with the array of one or more passages 946, are configured to distribute the first gas from the first gas distribution plenum 940 to the process space 462 of chemical treatment chamber 411. The second array of one or more orifices 948 is configured to distribute the second gas from the second gas distribution plenum 942 to the process space of chemical treatment chamber 411. As a result of this arrangement, the first gas and the second gas are independently introduced to the process space without any interaction or mixing, except in the process space 462.

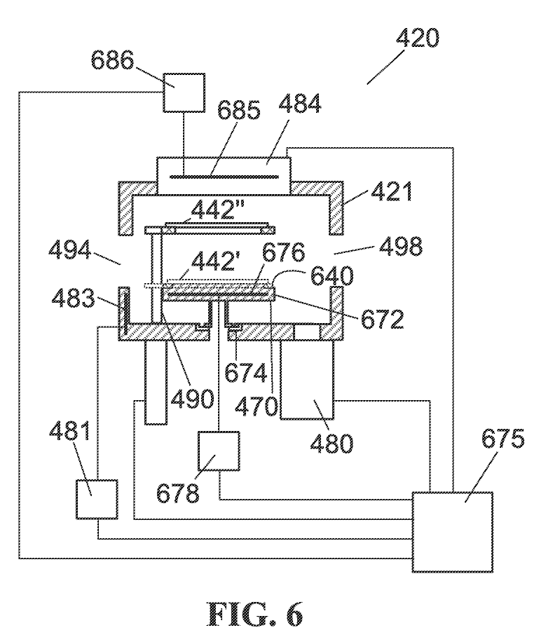

With reference to FIGS. 4 and 6, the thermal treatment system 420 further comprises a plurality of temperature controlled substrate holders 470 mounted within the thermal treatment chamber 421, a second vacuum pumping system 480 coupled in fluid communication with the thermal treatment chamber 421 and adapted to evacuate the thermal treatment chamber 421, and a substrate lifter assembly 490 coupled to the thermal treatment chamber 421. The substrate holders 470 are configured to be substantially thermally insulated from the thermal treatment chamber 421 and also configured to support a substrate 442′. The first vacuum pumping system 450 and the second vacuum pumping system 480 may be separate systems, or alternatively, may be the same vacuum pumping system.

As best shown in FIG. 6, each of the substrate holders 470 comprises a pedestal 672 thermally insulated from the thermal treatment chamber 421 using a thermal barrier 674. For example, each substrate holder 470 can be fabricated from aluminum, stainless steel, or nickel, and the thermal barrier 674 can be fabricated from a thermal insulator such as Teflon, alumina, or quartz. Each substrate holder 470 further comprises a heating element 676 embedded therein and a temperature control unit 678 electrically coupled thereto. The heating element 676 can, for example, comprise a resistive heating element. The substrate holder temperature control unit 678 may, for example, comprise a controllable DC power supply electrically coupled with the heating element 676. Alternatively, the heating element 676 for at least one of the temperature controlled substrate holders 470 can, for example, be a cast-in heater commercially available from Watlow (Batavia, Ill.) capable of a maximum operating temperature of about 400° C. to about 450° C., or a film heater comprising aluminum nitride materials that is also commercially available from Watlow and capable of operating temperatures as high as about 300° C. and power densities of up to about 23.25 W/cm². Alternatively, a cooling element can be incorporated in at least one of the substrate holders 470.

The temperature of the temperature controlled substrate holder 470 can be monitored using a temperature-sensing device such as a thermocouple (e.g. a K-type thermocouple). Furthermore, a controller can utilize the temperature measurement as feedback to the substrate holder temperature control unit 678 in order to control the temperature of the substrate holder 470.

Alternatively, the substrate temperature can be monitored using a temperature-sensing device such as an optical fiber thermometer commercially available from Advanced Energies, Inc. (Fort Collins, Colo.), Model No. OR2000F capable of measurements from about 50° C. to about 2000° C. and an accuracy of about plus or minus 1.5° C. Another suitable temperature-sensing device is a band-edge temperature measurement system as described in commonly-assigned U.S. Pat. No. 6,891,124, the disclosure of which is hereby incorporated herein by reference herein in its entirety.

Thermal treatment system 420 further comprises a temperature controlled thermal treatment chamber 421 that may be maintained at a selected temperature. For example, a heating element 483 can be electrically coupled to a temperature control unit 481, and the heating element 483 can be configured to transfer heat to the wall of the thermal treatment chamber 421. The heating element 483 can, for example, comprise a resistive heating element. The temperature control unit 481 can, for example, comprise a controllable DC power supply coupled with the heating element 483. Alternatively, or in addition, cooling elements may be employed in thermal treatment chamber 421. The temperature of the thermal treatment chamber 421 can be monitored using a temperature-sensing device such as a thermocouple (e.g. a K-type thermocouple, Pt sensor, etc.). Furthermore, a controller can utilize the temperature measurement as feedback to the control unit 468 in order to control the temperature of the thermal treatment chamber 421.

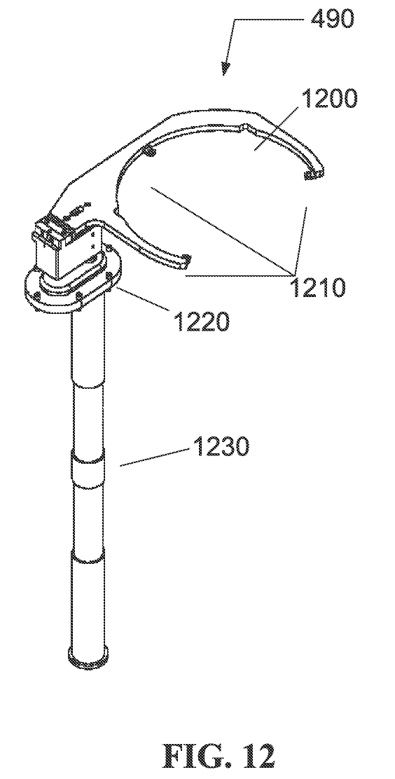

Thermal treatment system 420 further comprises an upper assembly 484 that can, for example, comprise a gas injection system for introducing a purge gas, process gas, or cleaning gas to the thermal treatment chamber 421. Alternatively, thermal treatment chamber 421 can comprise a gas injection system separate from the upper assembly. For example, a purge gas, process gas, or cleaning gas can be introduced to the thermal treatment chamber 421 through a side wall thereof. It can further comprise a cover or lid having at least one hinge, a handle, and a clasp for latching the lid in a closed position. In an alternate embodiment, the upper assembly 484 can comprise a radiant heater such as an array of tungsten halogen lamps for heating substrate 442″ resting atop blade 1200 (see FIG. 12) of substrate lifter assembly 490. In this case, the substrate holder 470 could be excluded from the thermal treatment chamber 421.

Thermal treatment system 420 can further comprise a temperature controlled upper assembly 484 that can be maintained at a selected temperature. For example, a heating element 685 can be electrically coupled to a temperature control unit 686, and the heating element 685 can be configured to transfer heat to the upper assembly 484. The heating element 685 can, for example, comprise a resistive heating element. The upper assembly temperature control unit 686 can, for example, comprise a controllable DC power supply electrically coupled with the heating element 685. The temperature of the upper assembly 484 can be monitored using a temperature-sensing device such as a thermocouple (e.g. a K-type thermocouple, Pt sensor, etc.). Furthermore, a controller can utilize the temperature measurement as feedback to the temperature control unit 686 in order to control the temperature of the upper assembly 484. Upper assembly 484 may additionally or alternatively include a cooling element.

Thermal treatment system 420 further comprises a second vacuum pumping system 480. Vacuum pumping system 480 can, for example, comprise a vacuum pump, and a throttle valve such as a gate valve or butterfly valve. The vacuum pump can, for example, include a TMP capable of a pumping speed up to about 5000 liters per second (and greater). For high pressure processing (i.e., greater than about 100 mTorr), a mechanical booster pump and dry roughing pump can be used.

Referring again to FIG. 6, thermal treatment system 420 can further comprise a second controller 675 having a microprocessor, memory, and a digital I/O port capable of generating control voltages sufficient to communicate and activate inputs to thermal treatment system 420 as well as monitor outputs from thermal treatment system 420. Moreover, the second controller 675 can be coupled to and can exchange information with substrate holder temperature control unit 678, upper assembly temperature control unit 686, upper assembly 484, thermal wall temperature control unit 481, vacuum pumping system 480, and substrate lifter assembly 490. For example, a program stored in the memory can be utilized to activate the inputs to the aforementioned components of thermal treatment system 420 according to a process recipe. One example of the second controller 675 is a DELL PRECISION WORKSTATION 610™ commercially available from Dell Corporation (Austin, Tex.).

In one embodiment, controllers 535 and 675 may be the same controller.

Referring to FIGS. 4, 6, and 12, thermal treatment system 420 further comprises a substrate lifter assembly 490. Substrate lifter assembly 490 can vertically translate the substrate 442″ between a holding plane (solid lines) and the substrate holder 470 (dashed lines), or at an intermediate transfer plane (not shown). More specifically, the substrate lifter assembly 490 is configured to lower a substrate 442′ to an upper surface of the substrate holder 470, as well as raise a substrate 442″ from an upper surface of the substrate holder 470 to the holding plane, or alternatively to the intermediate transfer plane. At the transfer plane, substrate 442″ can be exchanged with a transfer system utilized to transfer substrates into and out of the chemical and thermal treatment chambers 411, 421. At the holding plane, substrate 442″ can be cooled while another substrate is exchanged between the transfer system and the chemical and thermal treatment chambers 411, 421.

As best shown in FIG. 12, the substrate lifter assembly 490 comprises a blade 1200 having three or more tabs 1210, a flange 1220 for coupling the substrate lifter assembly 490 to the thermal treatment chamber 421, and a drive system 1230 for permitting vertical translation of the blade 1200 within the thermal treatment chamber 421. The tabs 1210 are configured to grasp substrate 442″ in a raised position, and to recess within receiving cavities 640 formed within the substrate holder 470 (see FIG. 6) when in a lowered position. The drive system 1230 can, for example, be a pneumatic drive system designed to meet various specifications including cylinder stroke length, cylinder stroke speed, position accuracy, non-rotation accuracy, etc., the design of which is known to those skilled in the art of pneumatic drive system design.

In one embodiment, each of the heating elements 466, 483, 567, 685 may comprise a resistive heating element, such as a tungsten, nickel-chromium alloy, aluminum-iron alloy, aluminum nitride, etc., filament. Exemplary materials for such resistive heating elements include, but are not limited to, KANTHAL®, NIKROTHAL®, and AKRONTHAL®, which are commercially available from Kanthal Corporation (Bethel, Conn.). The KANTHAL® family includes ferritic alloys (FeCrAl) and the NIKROTHAL® family includes austenitic alloys (NiCr, NiCrFe). When an electrical current flows through such a resistive heating element, power is dissipated as heat.

In an alternative embodiment, either of the heating elements 466, 483 may comprise at least one Firerod cartridge heater commercially available from Watlow (Batavia, Ill.). In an alternative embodiment, either of the heating elements 567, 685 may comprise a dual-zone silicone rubber heater (about 1.0 mm thick) capable of about 1400 W (or power density of about 5 W/in²).

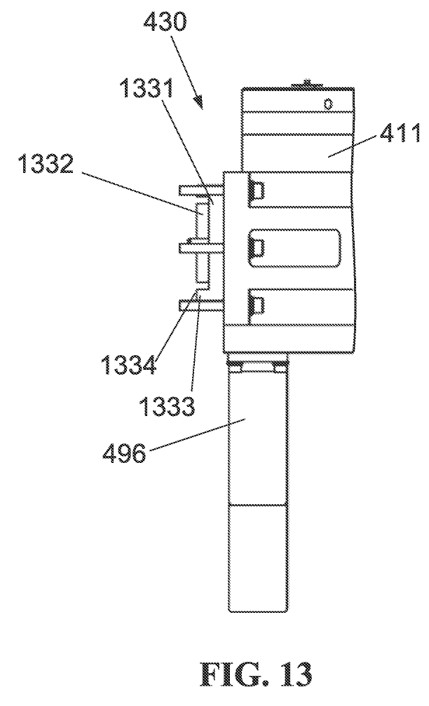

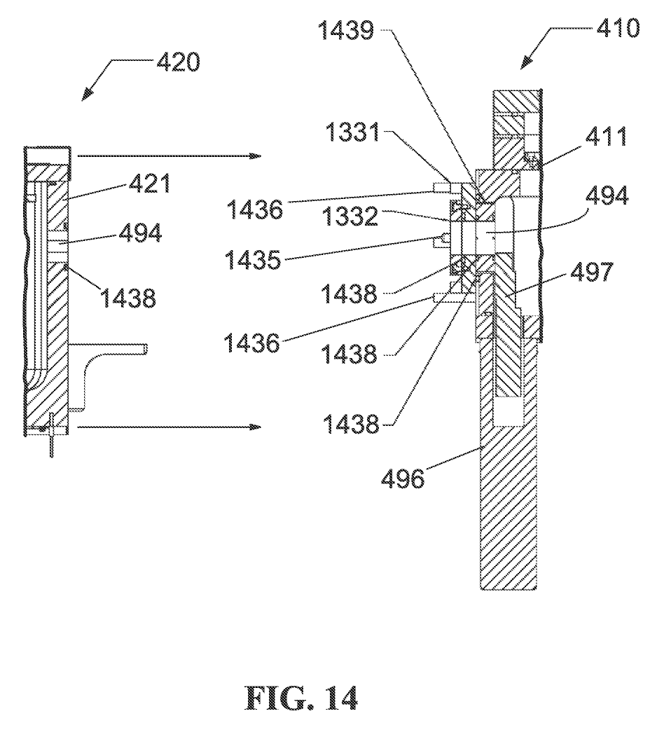

With reference to FIGS. 5, 13, and 14, thermal insulation assembly 430 can comprise an interface plate 1331 coupled to, for example, the chemical treatment chamber 411, as shown in FIG. 13, and configured to form a structural contact between the thermal treatment chamber 421 (see FIG. 14) and the chemical treatment chamber 411, and an insulator plate 1332 coupled to the interface plate 1331 and configured to reduce the thermal contact between the thermal treatment chamber 421 and the chemical treatment chamber 411. Furthermore, in FIG. 13, the interface plate 1331 comprises one or more structural contact members 1333 having a mating surface 1334 configured to couple with a mating surface on the thermal treatment chamber 421. The interface plate 1331 can be fabricated from a metal, such as aluminum, stainless steel, etc., in order to form a rigid contact between the two chambers 411, 421. The insulator plate 1332 can be fabricated from a material having a low thermal conductivity such as Teflon, alumina, quartz, etc.

Gate valve assembly 496 is utilized to vertically translate a gate valve 497 in order to open and close the common opening 494. The gate valve assembly 496 can further comprise a gate valve adaptor plate 1439 that provides a vacuum seal with the interface plate 1331 and provides a seal with the gate valve 497.

The two chambers 411, 421 can be coupled to one another using one or more alignment devices 1435 and terminating in one or more alignment receptors 1435′, and one or more fastening devices 1436 (i.e. bolts) extending through a flange on the first chamber (e.g. chemical treatment chamber 411). As shown in FIG. 14, a vacuum seal can be formed between the insulator plate 1332, the interface plate 1331, the gate valve adaptor plate 1439, and the chemical treatment chamber 411 using, for example, one or more elastomer o-ring seals 1438, and a vacuum seal can be formed between the interface plate 1331 and the thermal treatment chamber 421 via o-ring seals 1438.

Furthermore, one or more surfaces of the components comprising the chemical treatment chamber 411 and the thermal treatment chamber 421 can be coated with a protective barrier. The protective barrier can comprise at least one of Kapton, Teflon, surface anodization, ceramic spray coating such as alumina, yttria, plasma electrolytic oxidation, etc.

An assembly similar to thermal insulation assembly 430 can also be used as isolation assembly 150.

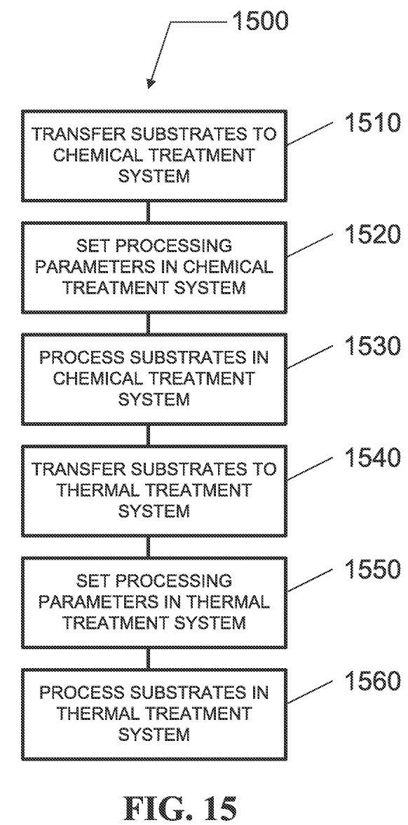

With reference to FIG. 15, a method of operating the processing system 100 (FIGS. 1-14) is presented as a flowchart 1500. In block 1510, the substrates 442 are transferred to the chemical treatment system 410 using the transfer system 130. One of the substrates 442 is received by lift pins 762 that are housed within each substrate platform 440, and the substrates 442 are lowered to the substrate platform 440. Thereafter, the substrate 442 is secured to the substrate platform 440 using the electrostatic clamping system 728 and a heat transfer gas is supplied to the backside of the substrate 442.

In block 1520, one or more chemical processing parameters for chemical treatment of the substrate 442 are set. For example, the one or more chemical processing parameters comprise at least one of a processing pressure, a wall temperature, a substrate platform temperature, a substrate temperature, a gas distribution temperature, and a gas flow rate. For example, one or more of the following may occur: 1) the first controller 535 coupled to the temperature control unit 468 and a first temperature-sensing device is used to set a temperature for the chemical treatment chamber 411; 2) the first controller 535 coupled to a temperature control unit 569 and a second temperature-sensing device is utilized to set a chemical treatment system temperature for the chemical treatment chamber 411; 3) the first controller 535 coupled to at least one temperature control element and a third temperature-sensing device is utilized to set a temperature for substrate platform 440; 4) the first controller 535 coupled to at least one of a temperature control element, a backside gas supply system, and a clamping system, and a fourth temperature sensing device in each substrate platform 440 is used to set a substrate temperature; 5) the first controller 535 coupled to at least one of the first vacuum pumping system 450 or the gas distribution system 460, and a pressure-sensing device is utilized to set a processing pressure within the chemical treatment chamber 411; and/or 6) the mass flow rates of the one or more process gases are set by the first controller 535 coupled to the one or more mass flow controllers within the gas distribution system.

In block 1530, the substrate 442 is chemically treated under the conditions set forth in block 1520 for a first period of time. The first period of time can range, for example, from about 10 seconds to about 480 seconds.

In block 1540, the substrate 442 is transferred from the chemical treatment chamber 411 to the thermal treatment chamber 421. During this time, the substrate clamp is removed, and the flow of heat transfer gas to the backside of the substrate 442 is discontinued. The substrate 442 is lifted vertically from the substrate platform 440 to the transfer plane using the lift pin assembly 760 housed within the substrate platform 440. The transfer system 130 receives the substrate 442 from the lift pins 762 and positions the substrate 442 within the thermal treatment system 420. Therein, the substrate lifter assembly 490 receives the substrate 442 from the transfer system 130, and lowers the substrate 442 to the substrate holder 470.

In block 1550, thermal processing parameters for thermal treatment of the substrate 442 are set. For example, the one or more thermal processing parameters comprise at least one of a wall temperature, an upper assembly temperature, a substrate temperature, a substrate holder temperature, and a processing pressure. For example, one or more of the following may occur: 1) the second controller 675 coupled to the temperature control unit 481 and a first temperature-sensing device in the thermal treatment chamber 421 is used to set a wall temperature; 2) the second controller 675 coupled to the temperature control unit 686 and a second temperature-sensing device in the upper assembly 484 is used to set an upper assembly temperature; 3) the second controller 675 coupled to temperature control unit 678 and a third temperature-sensing device in the heated substrate holder 470 is used to set a substrate holder temperature; 4) the second controller 675 coupled to a temperature control unit 678 and a fourth temperature-sensing device in the heated substrate holder 470 and coupled to the substrate 442 is used to set a substrate temperature; and/or 5) the second controller 675 coupled to second vacuum pumping system 480, gas distribution system 460, and the pressure sensing device is used to set a processing pressure within the thermal treatment chamber 421.

In block 1560, the substrate 442 is thermally treated under the conditions set forth in block 1550 for a second period of time. The second period of time can range, for example, from about 10 seconds to about 480 seconds.

In a specific example, the processing system 100, as depicted in FIGS. 1-3, can comprise a high-throughput system for the chemical oxide removal system for trimming an oxide hard mask, as described in U.S. Pat. No. 5,282,925, issued on Feb. 1, 1994, the disclosure of which is hereby incorporated by reference herein in its entirety. The processing system 100 comprises chemical treatment system 410 for chemically treating exposed surface layers, such as oxide surface layers, on a substrate, whereby adsorption of the process chemistry on the exposed surfaces affects chemical alteration of the surface layers. Additionally, the processing system 100 comprises thermal treatment system 420 for thermally treating the substrate, whereby the substrate temperature is elevated in order to desorb (or evaporate) the chemically altered exposed surface layers on the substrate.

To practice this specific process, the process space 462 (FIG. 4) in the chemical treatment system 410 is evacuated, and a process gas comprising HF and NH₃ is introduced. Alternatively, the process gas can further comprise a carrier gas. The carrier gas can, for example, comprise an inert gas such as argon, xenon, helium, etc. The processing pressure can range from about 1 mTorr to about 100 mTorr. Alternatively, the processing pressure can range from about 2 mTorr to about 25 mTorr. The process gas flow rates can range from about 1 sccm to about 200 sccm for each gas species. Alternatively, the flow rates can range from about 10 sccm to about 100 sccm. Although the first vacuum pumping system 450 is shown in FIGS. 4 and 5 to access the chemical treatment chamber 411 from the side, a uniform (three-dimensional) pressure field can be achieved. Table I illustrates the dependence of the pressure uniformity at the substrate surface as a function of processing pressure and the spacing between the gas distribution system 460 and the upper surface of substrate 442.

TABLE I

| (%) | h (spacing) | | | | |
|---|---|---|---|---|---|
| Pressure | 50 mm | 62 | 75 | 100 | 200 |
| 20 mTorr | 0.6 | NA | NA | NA | NA |
| 9 | NA | NA | 0.75 | 0.42 | NA |
| 7 | 3.1 | 1.6 | 1.2 | NA | NA |
| 4 | 5.9 | 2.8 | NA | NA | NA |
| 3 | NA | 3.5 | 3.1 | 1.7 | 0.33 |

Additionally, the chemical treatment chamber 411 can be heated to a temperature ranging from about 10° C. to about 200° C. Alternatively, the chamber temperature can range from about 35° C. to about 55° C. Additionally, the gas distribution system can be heated to a temperature ranging from about 10° C. to about 200° C. Alternatively, the gas distribution system temperature can range from about 40° C. to about 60° C. The substrate can be maintained at a temperature ranging from about 10° C. to about 50° C. Alternatively, the substrate temperature can range from about 25° C. to about 30° C.

In an alternate embodiment, the chemical treatment chamber 411 is configured to introduce a process gas mixture comprising a first gaseous HF component and an optional second gaseous ammonia (NH₃) component. The two gaseous components may be introduced together, or independently of one another. Additionally, either gaseous component, or both, can be introduced with a carrier gas, such as an inert gas. The inert gas can comprise a Noble gas, such as argon. The chemical treatment of an oxide film on a plurality of substrates by exposing the oxide film to the two gaseous components causes a chemical alteration of a top oxide film surface to a self-limiting depth.

A processing pressure can range from approximately 1 mTorr to 1,000 Torr. Alternatively, the processing pressure can range from approximately 2 mTorr to 100 Torr. Alternatively, the processing pressure can range from approximately 5 mTorr to 500 mTorr. The process gas flow rates can range from approximately 1 sccm to 10,000 sccm for each component. Alternatively, the flow rates can range from approximately 10 sccm to 100 sccm for each component.

Additionally, the chemical treatment chamber 411 may be operated in a temperature range from about 10° C. to about 450° C. Alternatively, the chemical treatment chamber 411 temperature may range from about 30° C. to about 60° C. The temperature for the plurality of substrates 442 can range from approximately 10° C. to about 450° C. Alternatively, the substrate temperature can range from about 30° C. to about 60° C.

In the thermal treatment system 420, the thermal treatment chamber 421 can be heated to a temperature ranging from about 20° C. to about 200° C. Alternatively, the chamber temperature can range from about 75° C. to about 100° C. Additionally, the upper assembly can be heated to a temperature ranging from about 20° C. to about 200° C. Alternatively, the upper assembly temperature can range from about 75° C. to about 100° C. The substrate can be heated to a temperature in excess of about 100° C., for example, from about 100° C. to about 200° C. Alternatively, the substrate temperature can range from about 50° C. to about 100° C.

In another embodiment, the thermal treatment system 420 can elevate the temperature of the plurality of substrates 442 to a temperature range from approximately 50° C. to approximately 450° C., and desirably, the plurality of substrates 442 temperature can range from approximately 100° C. to approximately 300° C. For example, the substrate temperature may range from approximately 100° C. to approximately 200° C. The thermal treatment of the chemically altered oxide surface layers may cause the evaporation or vaporization of surface layers.

The chemical treatment and thermal treatment described herein can produce an etch amount of an exposed oxide surface layer in excess of about 10 nm per 60 seconds of chemical treatment for thermal oxide, an etch amount of the exposed oxide surface layer in excess of about 25 nm per 180 seconds of chemical treatment for thermal oxide, and an etch amount of the exposed oxide surface layer in excess of about 10 nm per 180 seconds of chemical treatment for ozone TEOS. The treatments can also produce an etch variation across said substrate of less than about 2.5%.

A plurality of embodiments for performing high throughput non-plasma processing has been described. The foregoing description of the embodiments of the invention has been presented for the purposes of illustration and description. It is not intended to be exhaustive or to limit the invention to the precise forms disclosed. This description and the claims following include terms, such as left, right, top, bottom, over, under, upper, lower, first, second, etc. that are used for descriptive purposes only and are not to be construed as limiting. For example, terms designating relative vertical position refer to a situation where a device side (or active surface) of a substrate is the “top” surface of that substrate; the substrate may actually be in any orientation so that a “top” side of a substrate may be lower than the “bottom” side in a standard terrestrial frame of reference and still fall within the meaning of the term “top.” The term “on” as used herein (including in the claims) does not indicate that a first layer “on” a second layer is directly on and in immediate contact with the second layer unless such is specifically stated; there may be a third layer or other structure between the first layer and the second layer on the first layer. The embodiments of a device or article described herein can be manufactured, used, or shipped in a number of positions and orientations.

While the invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of applicants' general inventive concept.

1. A processing system for processing a plurality of substrates, each of the substrates carrying a layer, the processing system comprising:
a chemical treatment chamber comprising a process space, a plurality of temperature controlled substrate platforms configured to support the substrates in the process space, and a gas distribution system configured to deliver a plurality of process gases into the process space for chemically altering the layer on the substrates;
a thermal treatment chamber comprising a plurality of temperature controlled substrate holders; and
an isolation assembly disposed between the chemical treatment chamber and the thermal treatment chamber, the isolation assembly comprising a dedicated handler configured to transfer the substrates between the chemical treatment chamber and the thermal treatment chamber.

2. The processing system of claim 1 further comprising:
a controller configured to monitor and control at least one of a temperature of the chemical treatment chamber, a temperature of the gas distribution system, a temperature of the substrate holders of the chemical treatment chamber, a substrate temperature in the chemical treatment chamber, a processing pressure in the chemical treatment chamber, a gas flow rate in the chemical treatment chamber, a chamber temperature of the thermal treatment chamber, a temperature of the substrate holders of the thermal treatment chamber, a substrate temperature in the thermal treatment chamber, a processing pressure in the thermal treatment chamber, or a gas flow rate in the thermal treatment chamber.

3. The processing system of claim 1 wherein the isolation assembly provides at least one of thermal isolation and vacuum isolation.

4. The processing system of claim 1 wherein the isolation assembly further comprises at least one of a thermal insulation assembly or a gate valve assembly.

5. The processing system of claim 1 wherein the temperature controlled substrate platforms comprise at least one of an electrostatic clamping system, a back-side gas supply system, or a temperature control element.

6. The processing system of claim 1 wherein each of the substrate platforms includes a first heat exchange element selected from the group consisting of a cooling channel, a heating channel, a resistive heating element, and a thermoelectric device.

7. The processing system of claim 1 wherein the gas distribution system comprises a gas distribution plate with a plurality of gas injection orifices.

8. The processing system of claim 1 wherein the gas distribution system comprises a first gas distribution plenum and a first gas distribution plate having a first array of orifices and a second array of orifices, the first array of orifices for coupling a first gas to the process space, and a second gas distribution plenum and a second gas distribution plate having passages therein for coupling a second gas to the process space through the passages in the second gas distribution plate and the second array of orifices in the first gas distribution plate.

9. A method of treating a plurality of substrates in a system comprising a chemical treatment chamber coupled to a thermal treatment chamber, each of the substrates carrying a layer of a processable material, the method comprising:
exposing the substrates to a plurality of process gases in a chemical treatment system to chemically alter the processable material in the layer on each of the substrates;
heating the substrates and the layer on each of the substrates in a thermal treatment system;
transferring the substrates between the thermal treatment chamber and the chemical treatment chamber using a dedicated handler; and
isolating the chemical treatment chamber from the thermal treatment chamber when the substrates are being processed in the chemical treatment chamber or the thermal treatment chamber.

10. The method of claim 9 wherein the process gases comprise HF and NH₃.

11. The method of claim 9 wherein a temperature of the chemical treatment chamber ranges from about 10° C. to about 200° C.

12. The method of claim 9 wherein an operating pressure of the chemical treatment chamber ranges from about 1 mTorr to about 100 mTorr.

13. A method for treating a plurality of substrates, each of the substrates including at least one exposed oxide surface layer, the processing system comprising:
exposing the substrates to a plurality of process gases in a chemical treatment chamber to chemically alter the at least one exposed oxide surface layer on each of the substrates;
transferring the substrates from the chemical treatment chamber to a thermal treatment chamber;
thermally treating the at least one exposed oxide surface layer on each of the substrates in the treatment chamber, after exposure to the process gases, such that the at least one exposed oxide surface layer is etched; and
isolating the chemical treatment chamber and the thermal treatment chamber from each other during the chemical and thermal treatments.

14. The method of claim 13 wherein the exposed oxide surface layer is a thermal oxide, and the thermal treatment is effective to etch the thermal oxide in excess of about 10 nm per 60 seconds of chemical treatment.

15. The method of claim 13 wherein the exposed oxide surface layer is a thermal oxide, and the thermal treatment etches the thermal oxide in excess of about 25 nm per 180 seconds of chemical treatment.

16. The method of claim 13 wherein the exposed oxide surface layer is an ozone TEOS oxide, and the thermal treatment etches the ozone TEOS oxide in excess of about 10 nm per 180 seconds of chemical treatment.

17. The method of claim 13 wherein a variation of an etch amount for the at least one exposed oxide layer across at least one of the substrates is about 2.5% or less.
